(19) United States
(12) Patent Application Publication
(10) Pub. No.: US 2023/0124287 A1
(43) Pub. Date: Apr. 20, 2023

(54) Electric Handheld Filer

(71) Applicant: Christopher Nix, Chatsworth, GA (US)

(72) Inventor: Christopher Nix, Chatsworth, GA (US)

(21) Appl. No.: 17/718,369

(22) Filed: Apr. 12, 2022

Related U.S. Application Data
(60) Provisional application No. 63/255,550, filed on Oct. 14, 2021.

(51) Int. Cl. B24B 23/04; B24B 47/12

(52) U.S. Cl. CPC B24B 23/04; B24B 47/12

(57) ABSTRACT

The present invention relates to an electric handheld file tool for automatically filing down a workpiece. The electric filing tool is designed to save the time and effort associated with manually moving a file tool back and forth. A power source provides power to the motor of the device, and a linear motion is provided by a spindle to a file attachment for filing the workpiece. The spindle converts the rotational motion of the motor to reciprocating back and forth movement of the file attachment. The tool has an activation button for activating the tool, and a speed control button for controlling a speed of the file attachment. The filing tool can be used with a variety of removably attached file attachments, and can also be provided power using conventional 120-volt AC supply or battery power.

### CROSS-REFERENCE TO RELATED APPLICATION

The present application claims priority to, and the benefit of, U.S. Provisional Application No. 63/255,550, which was filed on Oct. 14, 2021, and is incorporated herein by reference in its entirety.

### FIELD OF THE INVENTION

The present invention relates generally to the material handheld tools. More specifically, the present invention relates to a novel material filing tool that automatically files down a workpiece without having to manually move the tool back and forth. The tool has a motor and a battery for automatically providing reciprocating movement of the file blade to file a workpiece. The tool can be selectively activated using an activation button and the speed of reciprocating movement can be selected using a speed control button. The tool reduces the time and effort spent on filing or abrading process of any material or workpiece. Accordingly, the present disclosure makes specific reference thereto. Nonetheless, it is to be appreciated that aspects of the present invention are also equally applicable to other like applications, devices and methods of manufacture.

### BACKGROUND

By way of background, filing is a removal process and is one of the most frequent operations in manufacturing, metal working, wood working and other operations where it is necessary to smooth or reduce the amount of material in a certain area. The filing process is commonly used on a wide range of materials as a finishing operation. More specifically, in filing, a portion of the material is removed or abraded using a file for providing the desired finish. Generally, operators use a hand file for filing metal, wood and other workpieces. A typical hand file is made from a bar of high-carbon steel with its teeth pressed, cut, or raised into the steel. The size and arrangement of the teeth vary depending on the type of filing that needs to be done. Operators need to manually move the conventional hand file back and forth to file a surface to the desired feel or depth. The surfaces that require filing are generally hard and an operator is required to put a lot of effort and time in manually filing the surface. This is not only time consuming but also exhausting as the user needs to make a number of repetitive motions in order to achieve the desired finished surface.

During filing process, an operator has to put a hand on or near the teeth of the file and that generally causes injury to palm and fingers of the operator if the hand slips on the teeth. Further, after spending some time manually filing surfaces, an operator may become tired and experience soreness in his or her arms due to the repetitive motion. Conventional hand files can be ineffective, cause discomfort and take excessive time in filing surfaces, and as such, people desire an improved automatic filing tool that can overcome the problems of the conventional hand files.

Therefore, there exists a long-felt need in the art for an electric handheld file tool that can be easily used by operators for filing virtually any surface or workpiece. There is also a long-felt need in the art for a filer tool that allows users to automatically file down any type of material. Additionally, there is a long-felt need in the art for a filing tool that provides a convenient method of filing down a material or workpiece. Moreover, there is a long-felt need in the art for an improved filing tool that reduces the time and effort spent by operators in filing surfaces. Further, there is a long-felt need in the art for an electric handheld file that eliminates the need for manually filing a surface by the individuals using the file. Furthermore, there is a long-felt need in the art for a filing tool that automatically allows back and forth or reciprocating movement of the file attachment. Finally, there is a long-felt need in the art for a handheld filer that saves extensive time and effort when filing wood, metal, and numerous other materials by automatically filing down any type of material or workpiece.

The subject matter disclosed and claimed herein, in one embodiment thereof, comprises a handheld electric filer tool. The handheld tool is configured to eliminate the manual back and forth movement of the filer and provide a more convenient method of filing down a material or other workpiece. The filer tool further includes: a handle, a 12-volt battery pack disposed in the handle and a housing, a miniature electronic motor being disposed in the housing, and a toggle activation button for activating the motor. A speed control knob is provided for controlling the rotational speed of the motor and a slot having a sliding groove for receiving and latching a file attachment for performing the filing operation on a subject work piece. Each file blade has a face with a plurality of cutting edges or teeth that extend from the heel of the file to the point or end of the file. The file blade is attached at the heel end and may have a tang to fit within a corresponding opening of the housing. A spindle connects the motor and the sliding groove and is configured to provide a reciprocating linear movement to the latched file blade attachment in accordance with rotation of the motor. The motor receives electric power from the battery pack for rotation.

In this manner, the handheld electric filer tool of the present invention accomplishes all of the forgoing objectives and provides users with an electric handheld file with multiple speed settings and blade attachments with a multiple face configuration. The tool can be used for filing a variety of surfaces without having to manually move the file back and forth. The automatic movement of the face of the file across the workpiece using the motor reduces the amount of time and effort spent by operators for filing surfaces or working on the material.

### SUMMARY OF THE INVENTION

The following presents a simplified summary in order to provide a basic understanding of some aspects of the disclosed innovation. This summary is not an extensive overview, and it is not intended to identify key or critical elements or to delineate the scope thereof. Its sole purpose is to present some general concepts in a simplified form as a prelude to the more detailed description that is presented later.

The subject matter disclosed and claimed herein, in one embodiment thereof, comprises a handheld electric filer tool. The tool further includes a handle, a battery pack disposed in the handle, a housing, and an electric motor disposed in the housing. An activation button is used for activating the motor and a speed control button is provided for controlling the rotational speed of the motor. A slot has a sliding groove for receiving and latching a file attachment blade for performing a filing operation on a subject work piece. A spindle connects the motor and the sliding groove and is configured to provide a reciprocating linear movement to the latched file attachment in accordance with rotation of the motor. Each file blade has a point and a heel, and a face disposed between the point and heel. The face is provided with a plurality of cutting points or teeth to abrade or file the workpiece.

In yet another embodiment, the file attachment moves in forward direction when the motor rotates in clockwise direction and the file attachment moves in backward direction when the motor rotates in counterclockwise direction.

In yet another embodiment, the electric motor is coupled to a gear system enabling the speed control button to control the rotational speed of the motor.

In yet another embodiment, the spindle translates the rotational motion of the motor into linear motion.

In yet another embodiment, the electric motor receives power from the battery pack through a first circuit.

In yet another embodiment, the tool provides a reciprocating movement of up to 30,000 strokes per minute for automatic filing of the workpiece.

In yet another embodiment, a handheld filer is disclosed for assisting with a more convenient method of filing down or abrading a material. The filer includes an activation switch for starting an internal motor, a speed control button for controlling the speed of the motor, a 12-volt battery pack or a 120-volt plug for providing electric power to the motor, a slot having a sliding groove for receiving linear movement from the motor and for providing back and forth reciprocating movement to an attached metal file or wood rasp. The file attachment is removably attached to the slot and can be removed when not required.

In yet another embodiment, the 12-volt battery pack is rechargeable.

In yet another embodiment, an operation of filing a surface without manually moving a filer back and forth by an operator is disclosed. The operation includes providing an electric handheld filer having a removably attached file or tool attachment. Next, placing the filer attachment on a subject work piece and activating the filer using an activation button disposed on the filer. A speed control button is used to control the speed of an integrated motor of the filer; and translating, using a spindle, rotatory motion of the motor into linear movement of the attached file attachment.

In yet another embodiment, the operation includes the step of removing the file attachment and replacing with an alternative file attachment. The file attachment may have a dampening material near the tang or insertion portion to help reduce the vibration of the tool so as not to cause any inadvertent damage to the workpiece or material being worked on.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the electric handheld metal and wood filer of the present invention in accordance with the disclosed architecture;

FIG. 2 illustrates a perspective view of various filing attachments that can be used with one potential embodiment of the electric filer tool of the present invention in accordance with the disclosed architecture;

FIG. 3 illustrates an exploded view of one potential embodiment of the handheld electric filer of the present invention in accordance with the disclosed architecture;

FIG. 4 illustrates a perspective view of an operator operating one potential embodiment of the handheld filing tool of the present invention in accordance with the disclosed architecture; and

FIG. 5 illustrates a close-up view of the sliding mechanism of one potential embodiment of the handheld electric filer of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for an electronic or electric handheld file tool that can be easily used by operators for filing virtually any surface or type of material. There is also a long-felt need in the art for a filer tool that allows users to automatically file down any type of material. Additionally, there is a long-felt need in the art for a filing tool that provides a convenient method of filing down or shaping a material. Moreover, there is a long-felt need in the art for an improved filing and shaping tool that reduces the time and effort spent by operators for filing and shaping such surfaces. Further, there is a long-felt need in the art for an electric handheld file and shaping tool that eliminates the need for manual filing of surfaces by operators. Furthermore, there is a long-felt need in the art for a filing and shaping tool that automatically allows back and forth or reciprocating movement of the file or shaping attachment. Finally, there is a long-felt need in the art for a handheld filer and shaping tool that saves extensive time and effort when filing or shaping wood, metal, and numerous other materials by automatically filing or shaping down any type of material.

The present invention, in one exemplary embodiment, is a novel handheld filer for automatically filing or shaping a material. The filer includes an activation switch for starting an internal motor, a speed control button for controlling speed of the motor, a 12-volt battery pack or a 120-volt plug for providing electric power to the motor, and a slot having a sliding groove for receiving linear movement from the motor and for providing back and forth reciprocating movement to an attached metal file, shaping tool or wood rasp. The file attachment is removably attached to the slot and can be removed when not required.

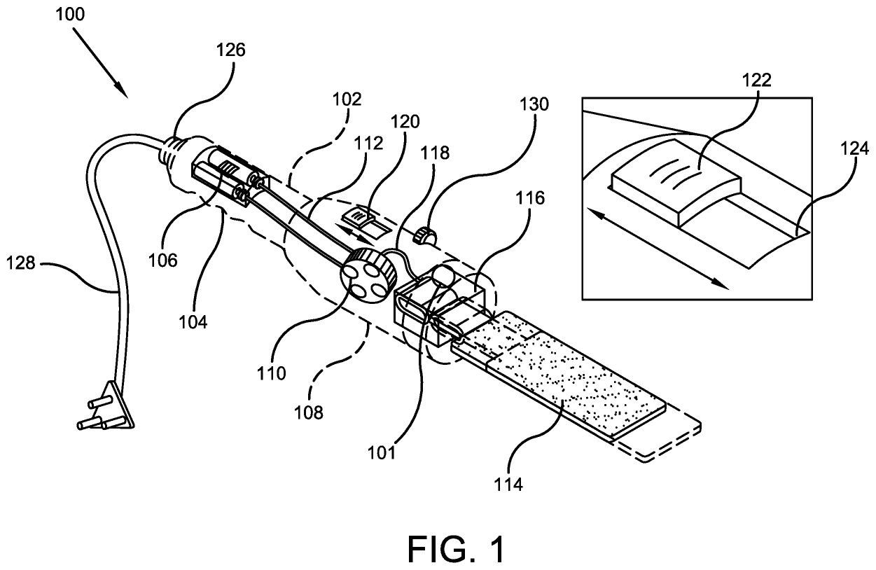

Referring initially to the drawings, FIG. 1 illustrates a perspective view of one potential embodiment of the electric handheld metal and wood filer of the present invention in accordance with the disclosed specification. The electric handheld metal and wood filer 100 of the present invention is designed to quickly file down, shape or smooth wood, metal, and various other materials. The filer 100 is a handheld tool and eliminates the need to use a conventional manual filer and thus helps in reducing labor and effort of an operator of the filer.

More specifically, the electric filer 100 has a handle 102 that has an ergonomic grip 104 for comfortable handling of the filer 100 during use. The handle 102 houses 12-volt batteries 106 for providing electric power for functioning of the filer 100. The handle 102 extends to a housing 108 that houses an internal miniature motor 110. The motor 110 is coupled to the batteries 106 using a first circuit 112. The motor 110 is configured to provide a reciprocating motion to a filer or shaping attachment 114 attached to a slot 116. The slot 116 is housed inside the housing 108 and is coupled to the internal motor 110 through a second circuit 118. The motor 110 rotates in clockwise and counterclockwise direction allowing a linear reciprocating motion to the attachment 114 removably attached to the slot 116. More specifically, the slot 116 provides a sliding groove wherein the attachment 114 easily slides for performing the reciprocating motion. The motor 110 is configured to receive electric power from the batteries 106 for providing reciprocating motion. The reciprocating motion of the filer attachment 114 allows the attachment to move forward (shown in phantom lines) and backward (shown in solid lines) frequently to replicate a manual filing operation performed by a user using conventional manual files.

The tool 100 has an activation button 120 disposed on the housing 108 that allows a user to manually activate the tool 100 for performing a filing operation. The activation button 120 can be toggled from an ON state to an OFF state and vice versa. The activation button 120 when in ON state 122, closes the first circuit 112 for allowing electric charge to flow from the batteries 106 to the motor 110 and when the activation button 120 is in OFF state 124, the first circuit 112 becomes open for not allowing electric charge to flow from the batteries 106 to the motor 110. The rear end 126 of the tool 100 has a 120-volt plug or power cord 128 for directly providing power to the motor 110. The batteries 106 can be rechargeable or disposable as required by the users and manufacturers.

The tool 100 can be made from a lightweight and durable metal, heavy duty plastic and any other similar material. Further, the handle 104 and the housing 108 can be integrally molded or can be removably attached to each other. The tool 100 provides the ability for a user to control the speed of reciprocating movement of the attachment 114 inserted into the slot 116 using the speed control button 130. The slot may have a locking button 101 which releasably locks the file blade attachment in position. The button 101 is depressed in order to release the attachment from the slot. The speed control button 140 is configured to be rotated clockwise to increase the speed of reciprocating motion and is configured to be rotated counterclockwise to decrease speed of reciprocating motion. The speed control button 140 can range the speed from about 15,000 strokes to 25,000 strokes per minute.

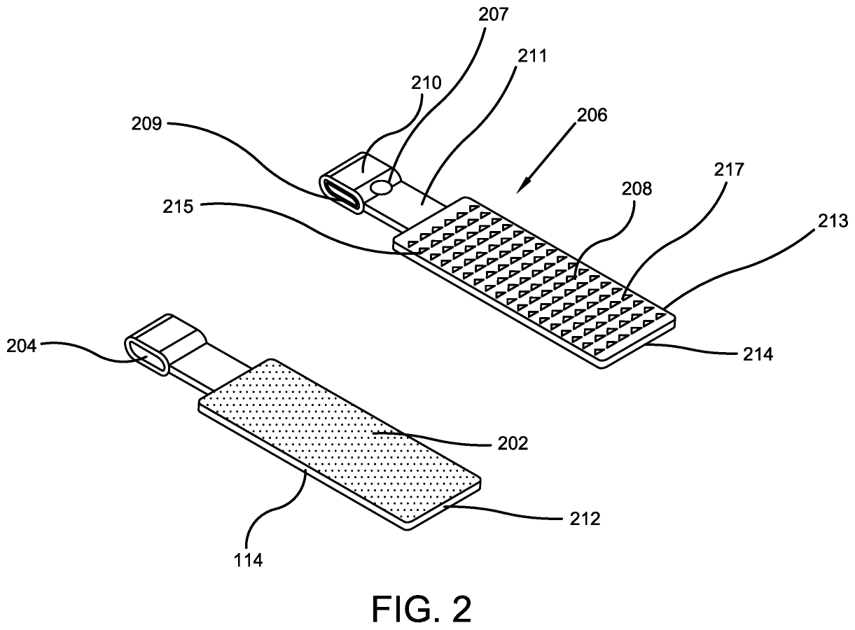

The handle 102 is about 1.25″ in diameter and 8″ in length. The housing 108 is about 3″ in diameter and 5″ in length. The filing attachment 114 is preferably 7″ in length and has a thickness of 4 mm. Further details of the attachments compatible to the tool 100 are described in FIG. 2.

FIG. 2 illustrates a perspective view of various filing attachments to be used with the electric filer tool of the present invention in accordance with the disclosed structure. As illustrated, the metal file 114 has a filing surface 202 for filing a material and has a connecting member 204 which may include a vibration damping material 209 for reducing the vibration. The vibration damping material 209 may be rubber, silicone, urethane foam or combinations thereof. The connecting member or tang 204 is configured for inserting into the slot 116 of the tool 100. The tang or connecting member 204 may also have a detent, hole or recessed area 207 which cooperates with the locking button 101 to hold the attachment in position within the handle. The metal file 114 is removably attached to the slot 116 and can be used for automatically filing a surface of a workpiece using the reciprocating motion of the file 114. The file 114 may come in a variety of widths like ¾″, 1″ and 1¼″. Further, the metal file 114 has a length of 7″ measured from the connecting member 210 to the farther end 212. The file 114 has a tang 211, first and second side edges 213 and 215 which form a periphery around the face 208 which has a plurality of teeth or other surface to create the filing or abrading activity. The face is one of a rasp cut, curved cut, plater's rasp, woodchuck, single cut, double cut, or bastard. The face has a coarseness of one of a bastard, second cut, smooth cut or Swiss cut.

A wooden rasp attachment 206 is used for coarsely shaping wood or other material. More specifically, the attachment 206 has a face 208 that includes a coarse surface with a number of cutting elements 217 that is used for shaping wood and has a connecting member 210 for connecting into the slot 116 of the tool 100. The wooden rasp 206 may come in a variety of widths like 1″, 1¼″ and 1½″. Further, the wooden rasp 206 has a length of 7″ measured from the connecting member 210 to the end or point 214.

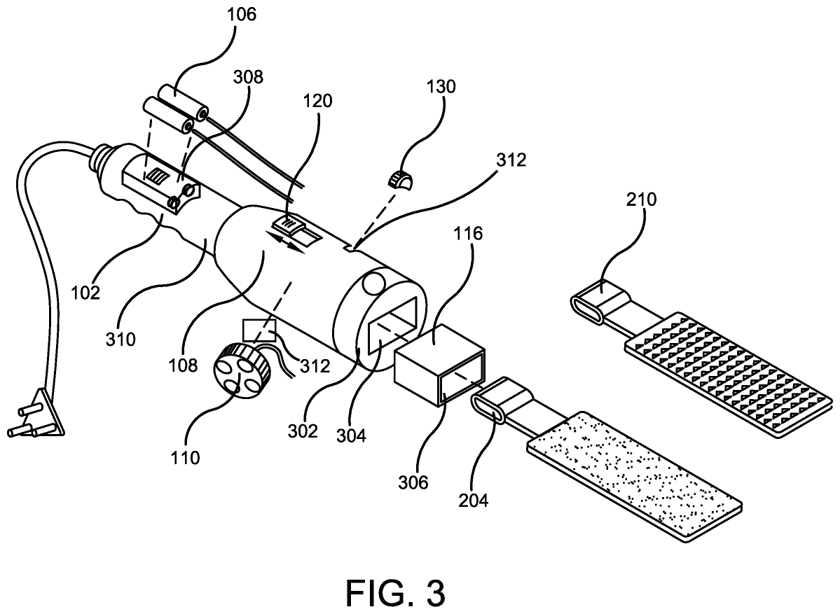

FIG. 3 illustrates an exploded view of the handheld electric filer 100 of the present invention in accordance with the disclosed specification. As illustrated, the front end 302 of the handle of the tool 100 has an opening slot 304 dimensioned to receive the front opening 306 of the slot 116 allowing the connecting members or tang 210, 212 of the file attachments to be easily inserted into the opening slot 304 and into front opening 306 of the slot 116. As stated earlier, the slot 116 provides a sliding groove for providing reciprocating motion to an attachment.

The electric motor 116 is configured to rotate as long as the operating switch 120 is actuated and is in an ON state. Further, the slot 116 is forced by the motor 110 into a periodic reciprocating movement along the longitudinal axis of the housing 108 and the file attachment. The speed control knob 130 is positioned inside a cut-out 312 and is coupled to the motor 110 through a gear mechanism 312.

The batteries 106 are protected by a battery cover 308 and the cover 308 is configured to be removed for removing or replacing batteries 106. Further, the handle 102 and the housing 108 are removably secured along the connecting means 310. The handle 102 and the housing 108 can be turned in opposite directions to remove the fastening connection therebetween for accessing the internal electronic components of the tool 100.

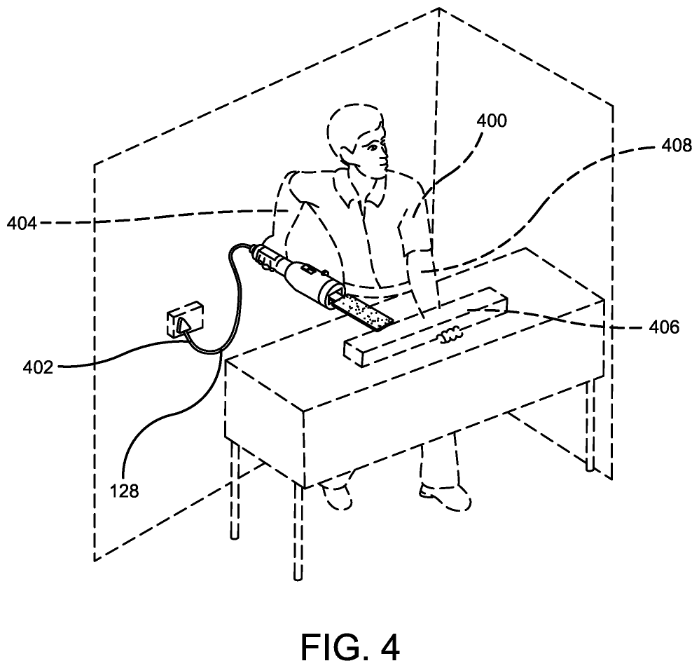

FIG. 4 illustrates a perspective view of an operator operating the handheld filing tool of the present invention in accordance with the disclosed specification. As illustrated, the tool 100 can be powered by plugging in the 120-volt plug or power cord 128 into a wall mounted or other power socket 402 such as a generator. In operation, an individual 400 can hold the tool 100 in his or her hand 404 while optionally holding the subject work piece 406 by the other hand 408. The reciprocating motion of the file attachment 114 allows a user to just hold the device 100 and not manually perform the filing operation on the subject work piece 406. The reciprocating movement in the range of up to 30,000 strokes per minute provides an extensive and effective filing or shaping operation that saves extensive time and effort when filing wood, metal, and numerous other materials using the tool 100.

Further, depending on the size, material, hardness or work piece 406, the speed of the reciprocating motion can be adjusted using the speed control button 130. The speed control button 130 can be used to select different hardness levels of the workpiece. It should be noted that the battery pack housed inside the tool 100 can also be used for operating the tool 100 without requiring the external electric power.

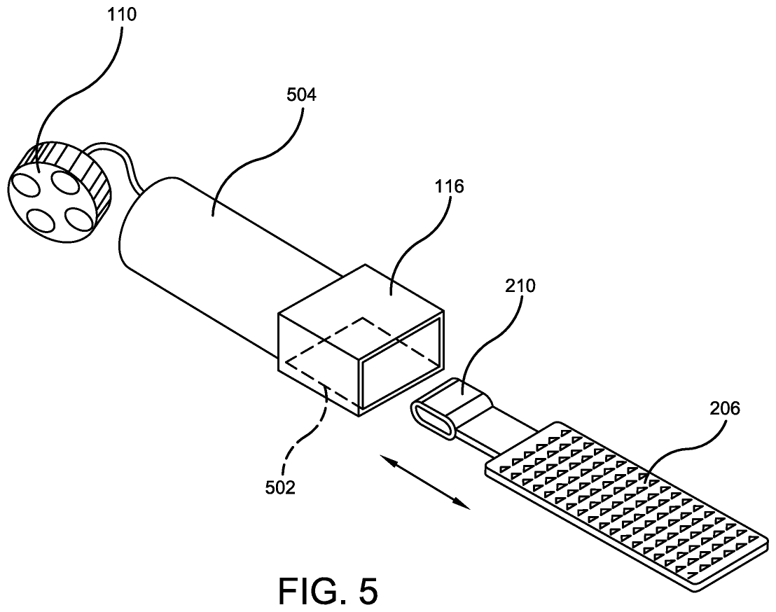

FIG. 5 illustrates a close view of the sliding mechanism of the tool 100 for producing reciprocating mechanism of the file attachment in accordance with the disclosed specification. As shown, the slot 116 has a sliding groove 502 positioned inside the slot 116 for receiving a connector or tang 210 of the file attachment 204 (or any other file attachment). The connector 210 is latched inside the groove 502 that allows reciprocating movement of the file attachment.

More specifically, a spindle 504 connects the motor 110 and the sliding groove 502. The spindle 504 performs a linear motion based on rotatory movement of the motor 110 and thereby allows the connector 210 latched in the sliding groove 502 to perform a reciprocating movement. More specifically, when the motor 110 rotates in clockwise direction, then the spindle 504 moves forward and thereby allows the file attachment to have a forward movement. Similarly, when the motor 110 rotates in counterclockwise direction, then the spindle 504 moves backward and the file attachment has a backward movement and thus completing reciprocating movement for performing automatic and effective filing of a workpiece.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “handheld filing tool”, “tool”, “electric handheld metal and wood filer”, “filer” and “electronic filer”, are interchangeable and refer to the electric handheld filer tool 100 of the present invention.

Notwithstanding the forgoing, the electric handheld filer tool 100 of the present invention can be of any suitable size and configuration as is known in the art without affecting the overall concept of the invention, provided that it accomplishes the above-stated objectives. One of ordinary skill in the art will appreciate that the electric handheld filer tool 100 as shown in the FIGS. are for illustrative purposes only, and that many other sizes and shapes of the electric handheld filer tool 100 are well within the scope of the present disclosure. Although the dimensions of the electric handheld filer tool 100 are important design parameters for user convenience, the electric handheld filer tool 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An electric file comprising:
a handle comprising a housing having an end,
a file attachment attached to the end of the housing, wherein the file attachment comprises a tang, first side, a second side, a point that is opposite the tang, and a face having a plurality of teeth or a course surface for filing or shaping a workpiece;
a battery positioned within the housing; and
a motor for providing a reciprocating motion to the file attachment.

2. The electric file as recited in claim 1, wherein the motor operates at about 15,000 strokes to 25,000 strokes per minute.

3. The electric file as recited in claim 1, wherein the handle has a connector for holding the file attachment.

4. The electric file as recited in claim 1, wherein the connector has a locking button for holding the file attachment in a desired position.

5. The electric file as recited in claim 4, wherein the tang of the file attachment has one of a detent, a recess or an opening for cooperating with the locking button to secure the file attachment to the housing.

6. The electric file as recited in claim 1, wherein the housing is about 3 inches in diameter and about 5 inches in length.

7. The electric file as recited in claim 1, wherein the filing attachment is about 7 inches in length, and has a thickness of about 4 mm.

8. The electric file as recited in claim 1, wherein the tang is comprised of a connector having a vibration damping material.

9. The electric file as recited in claim 8, wherein the vibration damping material is one of a rubber, a silicone, a urethane foam or a combination thereof.

10. The electric file as recited in claim 1, wherein the face is one of a rasp cut, a curved cut, a plater's rasp, a woodchuck, a single cut or a double cut.

11. The electric file as recited in claim 1, wherein the course surface of the face has a coarseness of one of a bastard, a second cut, a smooth cut or a Swiss cut.

12. The electric file as recited in claim 1 further comprising a speed control button.

13. A tool for filing a workpiece, comprising:
a handle having a housing and an ergonomic grip;
a motor positioned within the housing and in electrical communication with a power source;
a file attachment connected to the handle, wherein the file attachment is comprised of a tang positioned at a first end, a point positioned at a second opposing end, a first side, a second side and a face; and
a speed control for controlling a speed of movement of the file attachment.

14. The tool as recited in claim 13, wherein the motor operates at about 15,000 strokes to 25,000 strokes per minute.

15. The tool as recited in claim 13, wherein the handle further comprises an activation button for activating the tool.

16. The tool as recited in claim 13, wherein the power source is one of a battery or a 120 volt power outlet connected to a power cord.

17. The tool as recited in claim 13, wherein the connector of the file attachment comprises a vibration damping material.

18. The tool as recited in claim 17, wherein the vibration damping material is one of a rubber, a silicone, a urethane foam or a combination thereof.

19. The tool as recited in claim 17, wherein the face comprises a plurality of teeth for filing or shaping the workpiece.

20. A handheld filing tool comprising:
a housing comprised of a speed control button, an activation button and a handle having an ergonomic grip;
a motor connected to a power source; and
a file attachment having a connector and a face with a plurality of teeth to provide a filing surface, wherein the housing comprises a slot for receiving the connector of the file attachment, and further wherein the motor provides a reciprocating motion for driving the file attachment to file or abrade a work surface.
